(19) United States
(12) Patent Application Publication
(10) Pub. No.: US 2025/0342768 A1
(43) Pub. Date: Nov. 6, 2025

(54) METHOD AND SYSTEM FOR VALIDATING AIR TRAFFIC CONTROL INSTRUCTIONS FOR REDUCING RUNWAY INCURSION

(71) Applicant: Universal Avionics Systems Corporation, Tucson, AZ (US)

(72) Inventor: Thomas SMITH, Tucson, AZ (US)

(73) Assignee: Universal Avionics Systems Corporation, Tucson, AZ (US)

(21) Appl. No.: 19/192,501

(22) Filed: Apr. 29, 2025

Related U.S. Application Data
(60) Provisional application No. 63/641,485, filed on May 2, 2024.

(51) Int. Cl. G08G 5/26; B64D 43/00; G08G 5/23; G10L 15/26

(52) U.S. Cl. CPC G08G 5/26; B64D 43/00; G08G 5/23; G10L 15/26

(57) ABSTRACT

A method and system for validating Air Traffic Control (ATC) instructions for reducing runway incursion at an aerodrome. The method may include the following steps: identifying, using a voice-to-text software, audio ATC instructions broadcasted over an audio channel, for a specific aircraft based on an aircraft code; converting the audio ATC instructions for the specific aircraft into text, using the voice-to-text software, yielding ATC text instructions; presenting the ATC text instructions to a pilot of the specific aircraft, over an electronic display showing runways at the aerodrome and the location of the specific aircraft, and requesting the pilot to confirm receipt of the ATC text instructions; visualizing the ATC text instructions by presenting a route corresponding to the ATC text instruction along the runways presented over the electronic display; and alerting the pilot via the electronic display in a case that the specific aircraft strays away from the route.

### CROSS REFERENCE TO RELATED APPLICATION

This application is a U.S. Non-Provisional Patent Application, claiming priority from U.S. Provisional Patent Application No. 63/641,485 filed May 2, 2024, which is incorporated herein by reference in its entirety.

### FIELD OF THE INVENTION

The present invention relates generally to the field of flight safety, and more particularly to reducing runway incursion by validating control tower instructions

### BACKGROUND OF THE INVENTION

According to the Federal Aviation Administration (FAA), a Runway Incursion is defined as an occurrence at an aerodrome involving the incorrect presence of an aircraft, vehicle or person on the protected area of a surface designated for the landing and take-off of aircraft.

The FAA defines a surface incident as an unauthorized or unapproved movement within the designated movement area (excluding runway incursions) or an occurrence in that same area associated with the operation of an aircraft that affects or could affect the safety of flight.

Currently, Air Traffic Control (ATC) instructions are broadcasted over an audio communication channel open for receiving by many aircraft on taxi. The pilots listen carefully to this channel and once they recognize their own aircraft code they memorize or write down the instructions of how to perform the taxi at the aerodrome before take-off or after landing.

The drawbacks of the current handling of ATC instructions by the pilots is the burden on the pilots to memorize and follow the exact ATC instructions which may also change during taxi.

### SUMMARY OF THE INVENTION

In order to address the aforementioned drawbacks, some embodiments of the present invention improve basic technology and provide a computerized method and system for validating Air Traffic Control instructions for reducing runway incursion.

According to embodiments of the present invention, a method and system for validating Air Traffic Control (ATC) instructions for reducing runway incursion at an aerodrome are provided herein.

The method may include the following steps: identifying, using a voice-to-text software, audio ATC instructions broadcasted over an audio channel, for a specific aircraft based on an aircraft code; converting the audio ATC instructions for the specific aircraft into text, using the voice-to-text software, yielding ATC text instructions; presenting the ATC text instructions to a pilot of the specific aircraft, over an electronic display showing runways at the aerodrome and the location of the specific aircraft, and requesting the pilot to confirm receipt of the ATC text instructions; visualizing the ATC text instructions by presenting a route corresponding to the ATC text instruction along the runways presented over the electronic display; and alerting the pilot via the electronic display in a case that the specific aircraft strays away from the route.

Advantageously, the system and method in accordance with some embodiments of the present invention may provide an extra layer of safety by verifying the understanding of the control tower instructions by the pilot, by automatically checking the feedback from the pilot using a computerized platform.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a high-level block diagram illustrating a system for validating control tower instructions for reducing runway incursion in accordance with embodiments of the present invention;

FIG. 1B is a high-level block diagram illustrating, in more details, a system for validating control tower instructions for reducing runway incursion in accordance with embodiments of the present invention;

FIG. 2A is a high-level flowchart illustrating a method of validating control tower instructions for reducing runway incursion in accordance with some embodiments of the present invention;

FIG. 2B is a high-level flowchart illustrating an alternative method of validating control tower instructions for reducing runway incursion in accordance with other embodiments of the present invention;

FIG. 3 is a diagram illustrating an aspect a in accordance with some embodiments of the present invention; and

FIG. 4 is a diagram illustrating a further aspect a in accordance with some embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In the foregoing detailed description, numerous specific details are set forth in order to provide an understanding of the invention. However, it will be understood by those skilled in the art that the invention can be practiced without these specific details. In other instances, well-known methods, procedures, and components, modules, units, and/or circuits have not been described in detail so as not to obscure the invention. Some features or elements described with respect to one embodiment can be combined with features or elements described with respect to other embodiments.

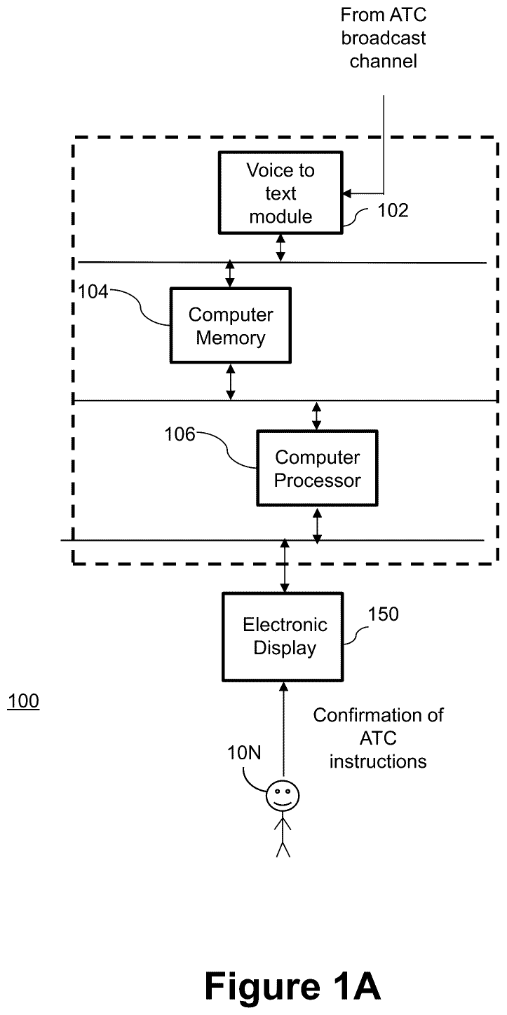

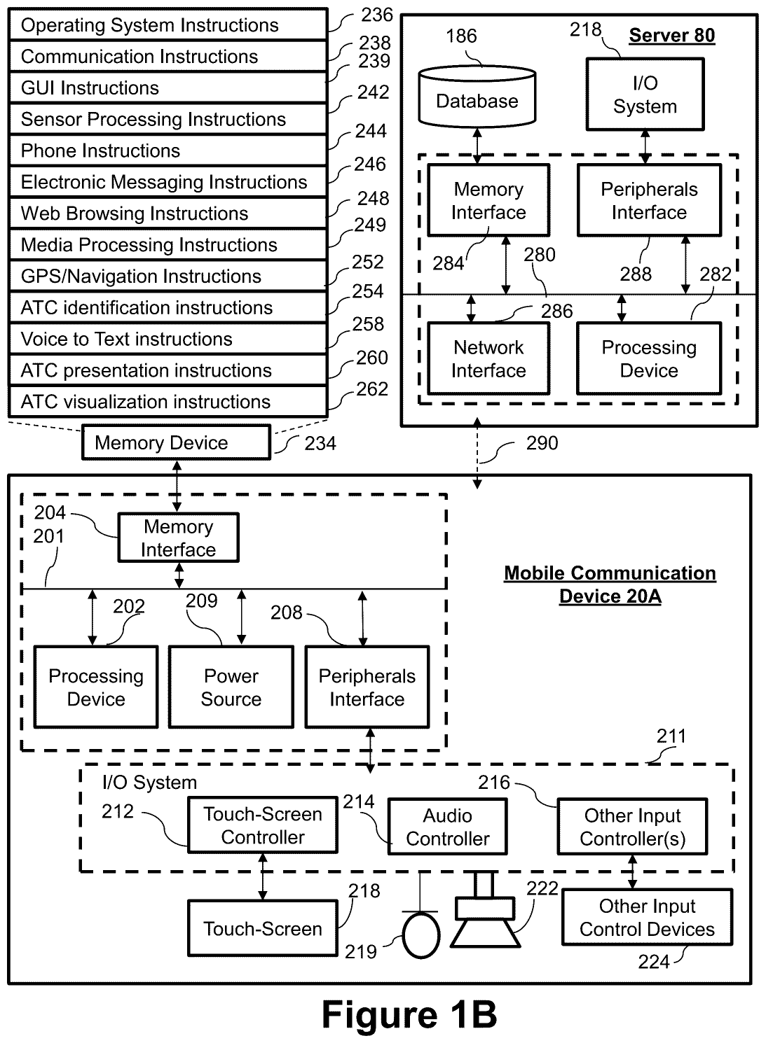

FIG. 1A is a high-level block diagram illustrating a system for validating Air Traffic Control (ATC) instructions for reducing runway incursion in an aerodrome. System 100 may include a computer processor 104; an electronic display 150, and computer readable medium such as computer memory 104 comprising a set of instructions that, when executed, cause computer processor 102 to: identify, using a voice-to-text module 102, audio ATC instructions broadcasted over an audio channel, for a specific aircraft based on an aircraft code; convert the audio ATC instructions for the specific aircraft into text, using the voice-to-text software, yielding ATC text instructions; present the ATC text instructions to a pilot of the specific aircraft, over electronic display 150 showing runways at the aerodrome and the location of the specific aircraft, and requesting the pilot to confirm receipt of the ATC text instructions; visualize the ATC text instructions by presenting a route corresponding to the ATC text instruction along the runways presented over the electronic display; and alert the pilot via the electronic display 150 in a case that the specific aircraft strays away from the route.

FIG. 1B shows a block diagram of the configuration of a mobile communication device 20A accessibly by a pilot and server 80 configured for validating Air Traffic Control (ATC) instructions for reducing runway incursion in an aerodrome.

With regard to the mobile communication device 20A, and according to some embodiments, the mobile communication device 20A, directly or indirectly, may access a bus 200 (or another data transfer mechanism) that interconnects subsystems and components for transferring information within the mobile communication device 20A. For example, bus 200 may interconnect a processing device 202, a memory interface 204, and a peripherals interface 208 connected to an I/O system 210. Power source 209 provides the power to the mobile communication device and it may include a primary or a rechargeable battery (not shown), DC-DC converters (not shown) and other components required for the proper operation mobile communication device 20A.

In some embodiments, processing device 202 may use a memory interface 204 to access data and a software product stored on a memory device 234 or a non-transitory computer-readable medium device 234.

According to some embodiments, the peripherals interface 208 may also be connected to sensors, devices, and subsystems to facilitate multiple functionalities. In one embodiment, the peripherals interface 208 may be connected to an I/O system 210 configured to receive signals or input from devices and to provide signals or output to one or more devices that allow data to be received and/or transmitted by the mobile communication device 20. In one example, the I/O system 210 may include a touch screen controller 212, audio controller 214, and/or other types of input controller(s) 216. The touch screen controller 212 may be coupled to a touch screen 218. The touch screen 218 and the touch screen controller 212 may, for example, detect contact, and movement, using any of a plurality of touch sensitivity technologies, including but not limited to capacitive, resistive, infrared, and surface acoustic wave technologies as well as other proximity sensor arrays or other elements for determining one or more points of contact with the touch screen 218. The touch screen 218 may also, for example, be used to implement virtual or soft buttons and/or a keyboard. While a touch screen 218 is shown in FIG. 1B, I/O system 210 may include a display screen (e.g., LCD or LED) in place of a touch screen 218.

Consistent with the present disclosure, the mobile communication device 20A may use a memory interface 204 to access a memory device 234. The memory device 234 may store an operating system 236, such as Android, IOS, MS Windows, Linux, or any other embedded operating system. Operating system 236 may include instructions for handling basic system services and for performing hardware-dependent tasks. In some implementations, the operating system 236 may be a kernel (e.g., Linux kernel).

The memory device 234 may also store communication instructions 238 to facilitate communicating with one or more additional devices, one or more computers, and/or one or more servers. The memory device 234 may include: graphical user interface instructions 240 to facilitate graphic user interface processing; sensor processing instructions 242 to facilitate sensor-related processing and functions; phone instructions 244 to facilitate phone-related processes and functions; electronic messaging instructions 246 to facilitate electronic-messaging-related processes and functions; web browsing instructions 248 to facilitate web browsing-related processes and functions; media processing instructions 250 to facilitate media processing-related processes and functions; GPS/navigation instructions 252 to facilitate GPS and navigation-related processes and instructions; capturing instructions 254 to facilitate processes and functions related to image sensor 226.

Each of the above-identified instructions and applications may correspond to a set of instructions for performing one or more functions described above. These instructions do not necessarily need to be implemented as separate software programs, procedures, or modules. The memory device 234 may include additional instructions or fewer instructions. Furthermore, various functions of the mobile communication device 20A may be implemented in hardware and/or software, including in one or more signal processing and/or application-specific integrated circuits.

Still referring to FIG. 1B, and according to some embodiments of the present invention, a server 80 for validating air traffic control instructions for reducing runway incursion accessed and presented by at least one mobile communication device 20A.

Processing device 282 may include at least one processor configured to execute computer programs, applications, methods, processes, or other software to perform embodiments described in the present disclosure.

In some embodiments, processing device 282 may use a memory interface 284 to access data and a software product stored on a memory device or a non-transitory computer-readable medium or to access a database 186.

According to some embodiments, the network interface 286 may provide two-way data communication to a network. In FIG. 1B, communication 290 between mobile communication device 20A and server 80 is represented by a dashed arrow. In one embodiment, the network interface 286 may include an integrated services digital network (ISDN) card, cellular modem, satellite modem, or a modem to provide a data communication connection over the Internet. As another example, the network interface 286 may include a wireless local area network (WLAN) card. In another embodiment, the network interface 286 may include an Ethernet port connected to radio frequency receivers and transmitters. The specific design and implementation of the network interface 286 may depend on the communications network(s) over which the mobile communication device 20A and the server 80 may communicate.

According to some embodiments, server 80 may also include a peripherals interface 288 coupled to the bus 280. The peripherals interface 288 may also be connected to devices, and subsystems to facilitate multiple functionalities as performed by the server 80. In some embodiments, those devices and subsystems may comprise a display screen (e.g., LCD) a USB port, and the like.

The components and arrangements shown in FIG. 1B for both server 80 and the mobile communication device 20A are not intended to limit the disclosed embodiments. As will be appreciated by a person skilled in the art having the benefit of this disclosure, numerous variations and/or modifications may be made to the depicted configuration of server 80 and the mobile communication device 20A. For example, not all the depicted components may be essential for the operation of server 80 or the mobile communication device 20A in all cases. Any component may be located in any appropriate part of server 80, and the components may be rearranged into a variety of configurations while providing the functionality of the disclosed embodiments.

According to some embodiments of the present invention, database 186 is configured to hold runway data of a plurality of aerodromes.

According to some embodiments of the present invention, memory device 234 may further include ATC identification instructions 254 which cause processing device 202, when executed to identify, audio ATC instructions broadcasted over an audio channel, for a specific aircraft based on an aircraft code.

According to some embodiments of the present invention, memory device 234 may further include voice to text instructions 258 which cause processing device 202, when executed to convert the audio ATC instructions for the specific aircraft into text, using the voice-to-text software, yielding ATC text instructions

According to some embodiments of the present invention, memory device 234 may further include Memory device 234 may further include ATC presentation instructions 260 which cause processing device 202 to present the ATC text instructions to a pilot of the specific aircraft, over touch screen 218 showing runways at the aerodrome and the location of the specific aircraft, and requesting the pilot to confirm receipt of the ATC text instructions.

According to some embodiments of the present invention, memory device 234 may further include Memory device 234 may further include ATC visualization instructions 262 which cause processing device 202 to visualize over touch screen 218 the ATC text instructions by presenting a route corresponding to the ATC text instruction along the runways presented over the electronic display; and optionally alert the pilot in a case that the specific aircraft strays away from the route.

In some embodiments, electronic displays such as touch screen 218 may be used to provide the pilot with other instructions and serve as a unified platform for communicating with the control tower and others.

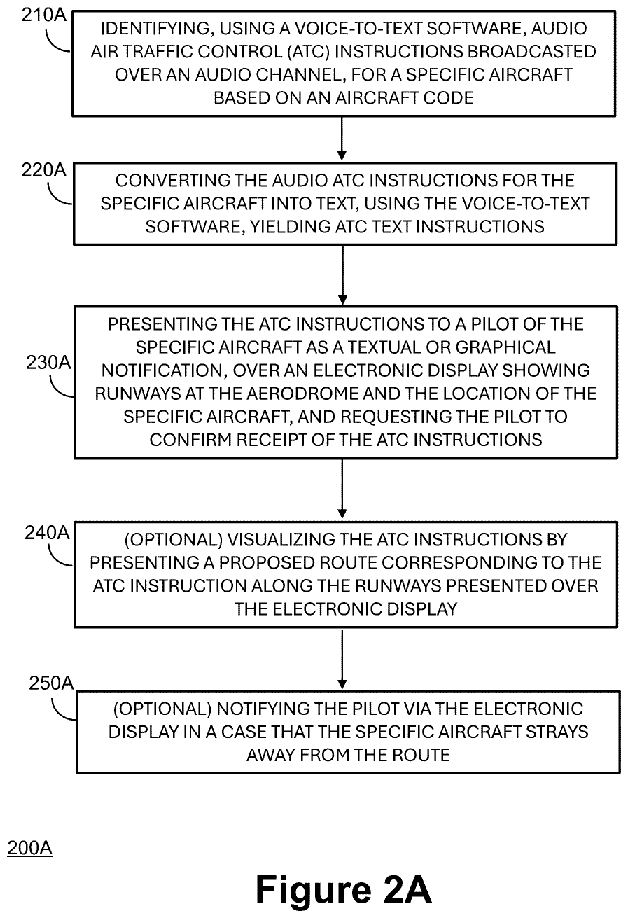

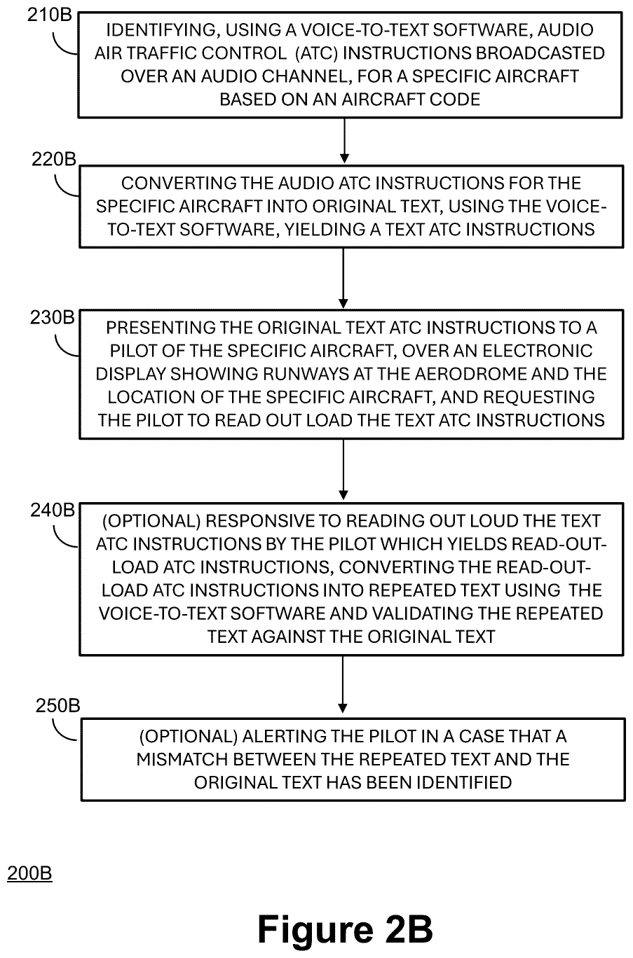

FIG. 2A is a high-level flowchart illustrating method 200A of validating control tower instructions for reducing runway incursion, in accordance with some embodiments of the present invention. Method 200A may include the following steps: identifying, using a voice-to-text software, audio ATC instructions broadcasted over an audio channel, for a specific aircraft based on an aircraft code 210A; converting the audio ATC instructions for the specific aircraft into text, using the voice-to-text software, yielding ATC text instructions 220A; presenting the ATC text instructions to a pilot of the specific aircraft, over an electronic display showing runways at the aerodrome and the location of the specific aircraft, and requesting the pilot to confirm receipt of the ATC instructions 230A; visualizing the ATC instructions by presenting a route corresponding to the ATC instruction along the runways presented over the electronic display 240A; and alerting the pilot via the electronic display in a case that the specific aircraft strays away from the route 250A.

FIG. 2B is a high-level flowchart illustrating an alternative method 200B of validating control tower instructions for reducing runway incursion, in accordance with alternative embodiments of the present invention. Method 200B may include the following steps: identifying, using a voice-to-text software, audio ATC instructions broadcasted over an audio channel, for a specific aircraft based on an aircraft code 210B; converting the audio ATC instructions for the specific aircraft into original text, using the voice-to-text software, yielding a text ATC instructions 220, presenting the original text ATC instructions to a pilot of the specific aircraft, over an electronic display showing runways at the aerodrome and the location of the specific aircraft, and requesting the pilot to read out load the text ATC instructions 230B; responsive to reading out loud the text ATC instructions by the pilot which yields read-out-load ATC instructions, converting the read-out-load ATC instructions into repeated text using the voice-to-text software and validating the repeated text against the original text 240B; and alerting the pilot in a case that a mismatch between the repeated text and the original text has been identified 250B.

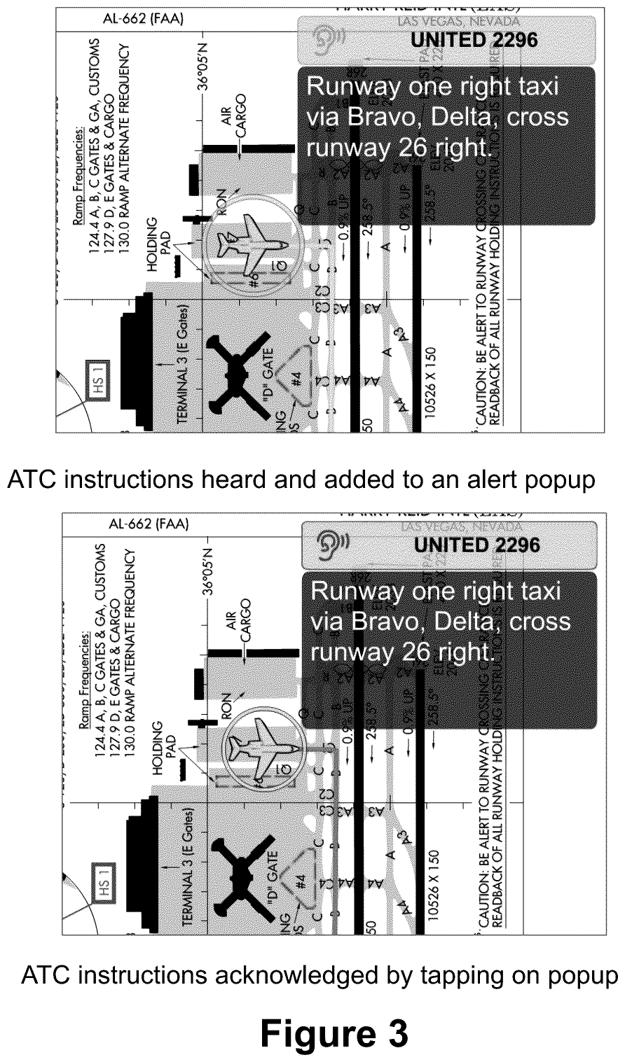

FIG. 3 is a diagram illustrating a display (top) presented to a pilot showing a pop-up (uppermost right corner) with the ATC instruction requesting the pilot to confirm safe receipt of the ATC instructions. Confirmation (bottom) can be achieved by tapping on the pop-up text or by reading out loud the ATC instruction text or other means.

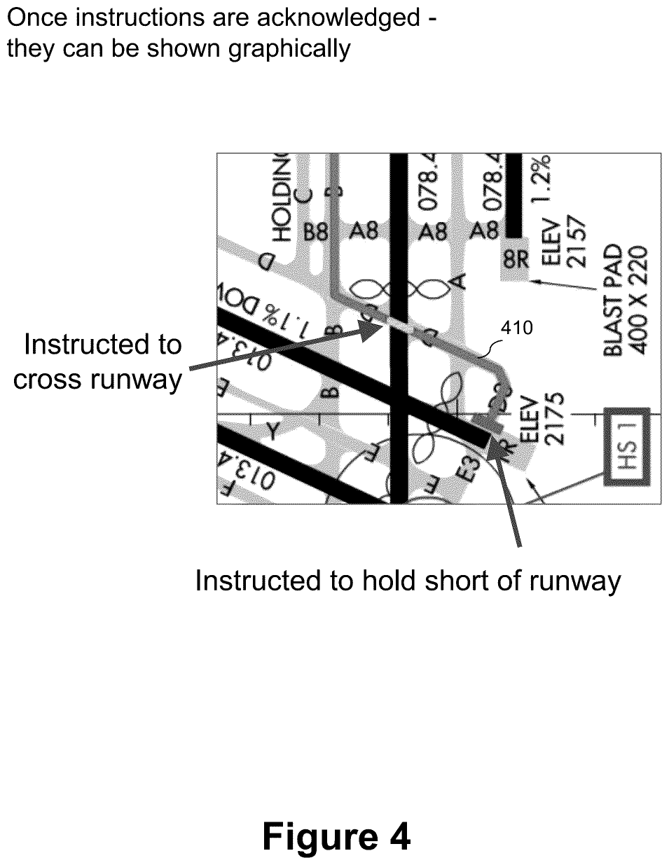

FIG. 4 is a diagram illustrating a further aspect a in accordance with some embodiments of the present invention. On the electronic display, as shown, when instructions are acknowledged they can be shown graphically by visualizing route 410 corresponding to the ATC instructions, possibly with arrows indicating specific points of importance along the route. The route may be updated on the go.

It is further understood that some embodiments of the present invention may be embodied in the form of a system, a method, or a computer program product. Similarly, some embodiments may be embodied as hardware, software, or a combination of both. Some embodiments may be embodied as a computer program product saved on one or more non-transitory computer-readable medium (or mediums) in the form of computer-readable program code embodied thereon. Such non-transitory computer-readable medium may include instructions that when executed cause a processor to execute method steps in accordance with embodiments. In some embodiments, the instructions stored on the computer-readable medium may be in the form of an installed application and in the form of an installation package.

Such instructions may be, for example, loaded by one or more processors and get executed. For example, the computer-readable medium may be a non-transitory computer-readable storage medium. A non-transitory computer-readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units, and/or circuits have not been described in detail so as not to obscure the invention. Some features or elements described with respect to one embodiment can be combined with features or elements described with respect to other embodiments.

1. A method of validating Air Traffic Control (ATC) instructions for reducing runway incursion in an aerodrome, the method comprising:
identifying, using a voice-to-text software, audio ATC instructions broadcasted over an audio channel, for a specific aircraft based on an aircraft code;
converting the audio ATC instructions for the specific aircraft into text, using the voice-to-text software, yielding ATC text instructions; and
presenting the ATC instructions to a pilot of the specific aircraft as a textual or graphical notification, over an electronic display showing runways at the aerodrome and the location of the specific aircraft, and requesting the pilot to confirm receipt of the ATC instructions.

2. The method of claim 1, further comprising visualizing the ATC instructions by presenting a proposed route corresponding to the ATC instruction along the runways presented over the electronic display.

3. The method of claim 2, further comprising notifying the pilot via the electronic display in a case that the specific aircraft strays away from the route.

4. The method of claim 1, further comprising: responsive to reading out loud the text atc instructions by the pilot which yields read-out-load ATC instructions, converting the read-out-load ATC instructions into repeated text using the voice-to-text software and validating the repeated text against the original text.

5. The method of claim 4, further comprising alerting the pilot in a case that a mismatch between the repeated text and the original text has been identified.

6. A system of validating Air Traffic Control (ATC) instructions for reducing runway incursion in an aerodrome, the system comprising:
a computer processor;
an electronic display;
computer readable medium comprising a set of instructions that, when executed, cause the computer processor to:
identify, using a voice-to-text software, audio ATC instructions broadcasted over an audio channel, for a specific aircraft based on an aircraft code;
convert the audio ATC instructions for the specific aircraft into text, using the voice-to-text software, yielding ATC text instructions; and
present the ATC instructions to a pilot of the specific aircraft as a textual or graphical notification, over the electronic display showing runways at the aerodrome and the location of the specific aircraft, and requesting the pilot to confirm receipt of the ATC instructions.

7. The system of claim 6, wherein the computer processor is further configured to visualize the ATC instructions by presenting a proposed route corresponding to the ATC instruction along the runways presented over the electronic display.

8. The system of claim 6, wherein the computer processor is further configured to notify the pilot via the electronic display in a case that the specific aircraft strays away from the route.

9. The system of claim 6, wherein the computer processor is further configured to: responsive to reading out loud the text ATC instructions by the pilot which yields read-out-load ATC instructions, convert the read-out-load ATC instructions into repeated text using the voice-to-text software and validating the repeated text against the original text.

10. The system of claim 9, wherein the computer processor is further configured to alert the pilot in a case that a mismatch between the repeated text and the original text has been identified.

11. A non-transitory computer readable medium for validating Air Traffic Control (ATC) instructions for reducing runway incursion in an aerodrome, the computer readable medium comprising a set of instructions that, when executed, cause at least one computer processor to:
identify, using a voice-to-text software, audio ATC instructions broadcasted over an audio channel, for a specific aircraft based on an aircraft code;
convert the audio ATC instructions for the specific aircraft into text, using the voice-to-text software, yielding ATC text instructions; and
present the ATC instructions to a pilot of the specific aircraft as a textual or graphical notification, over a electronic display showing runways at the aerodrome and the location of the specific aircraft, and requesting the pilot to confirm receipt of the ATC instructions.

12. The non-transitory computer readable medium of claim 11, further comprising a set of instructions that, when executed, cause the at least one computer processor to visualize the ATC instructions by presenting a proposed route corresponding to the ATC instructions along the runways presented over the electronic display.

13. The non-transitory computer readable medium of claim 11, further comprising a set of instructions that, when executed, cause the at least one computer processor to notify the pilot via the electronic display in a case that the specific aircraft strays away from the route.

14. The non-transitory computer readable medium of claim 11, further comprising a set of instructions that, when executed, cause the at least one computer processor to: responsive to reading out loud the text ATC instructions by the pilot which yields read-out-load ATC instructions, convert the read-out-load ATC instructions into repeated text using the voice-to-text software and validating the repeated text against the original text.

15. The non-transitory computer readable medium of claim 14, further comprising a set of instructions that, when executed, cause the at least one computer processor to alert the pilot in a case that a mismatch between the repeated text and the original text has been identified
